(19) United States
(12) Patent Application Publication
(10) Pub. No.: US 2013/0231958 A1
(43) Pub. Date: Sep. 5, 2013

(54) METHOD AND APPARATUS FOR PROVIDING PERSONAL HEALTH RECORD INFORMATION

(71) Applicant: SAMSUNG ELECTRONICS CO., LTD., Gyeonggi-do (KR)

(72) Inventors: Jun-Hyung KIM, Gyeonggi-do (KR); Jong-Hyo LEE, Gyeonggi-do (KR)

(73) Assignee: Samsung Electronics Co., Ltd., Gyeonggi-do (KR)

(21) Appl. No.: 13/785,607

(22) Filed: Mar. 5, 2013

(30) Foreign Application Priority Data
Mar. 5, 2012 (KR) 10-2012-0022367

(51) Int. Cl. G06F 19/00

(52) U.S. Cl. CPC G06F 19/322
USPC 705/3

(57) ABSTRACT

A method for providing Personal Health Record Information (PHR) in a terminal includes receiving a request for a PHR list from a healthcare terminal of manager, managing user's health, providing the PHR list to the healthcare terminal, receiving a request for at least one PHR included in the PHR list from the healthcare terminal, and performing authentication by reading the at least one PHR, wherein the healthcare terminal obtains the at least one PHR.

### PRIORITY

This application claims priority under 35 U.S.C. §119(a) to an application filed in the Korean Intellectual Property Office on Mar. 5, 2012 and assigned Serial No. 10-2012-0022367, the entire disclosure of which is incorporated herein by reference.

### BACKGROUND OF THE INVENTION

1. Field of the Invention

The present invention relates generally to a healthcare technology, and more particularly, to a method and apparatus for providing Personal Health

Record (PHR) information in which PHR can be managed and provided in a user-oriented (i.e., patient) manner.

2. Description of the Related Art

Recently, domestically and globally, the aging population and the social cost for senior healthcare are increasing. Additionally, personal and national expenditures for adult obese patient care or chronic disease management are also high. As the interest in personal health increases, individuals spend increasingly more money on personal health. Due to the national financial pressure corresponding to the medical and healthcare costs, the medical service is changing from a treatment-oriented service to a prevention/diagnosis-oriented service.

Currently, as part of hospital computerization, information about a clinical history, diagnoses, and treatment details of a patient is converted into an electronic document, as Personal Health Record information (PHR), to be stored and managed. The PHR has been used for various healthcare services. The PHR has been promoted as part of hospital computerization, and is used for medical treatment in hospitals, and the hospitals are now in charge of generation and management of the PHR.

However, each medical institution generates and manages PHR separately, and when a patient receives medical treatment in multiple medical institutions, the patient's personal medical record is distributed over the multiple medical institutions. Therefore, in order to read a patient's medical records, the patient has to request each medical institution to collect the medical record. If the patient has received medical treatment for the same symptom in different medical institutions, treatment results of the previous medical institution may be difficult to use or refer to. In addition, a medical record is generated in each medical institution, but the medical record is made using information of an individual patient, and management of the individual patient information is also required. However, as each medical institution manages the individual patient, it may arbitrarily share personal medical records with other medial institutions, resulting in an invasion of privacy and inadvertent release of private information.

### SUMMARY OF THE INVENTION

Accordingly, an aspect of the present invention is to solve the above-mentioned problems occurring in the prior art, and to provide at least the advantages below. According to an aspect of the present invention Personal Health Record (PHR) information method and apparatus is provided, in which PHR can be managed and provided in a patient-oriented manner.

According to an aspect of the present invention, there is provided a method for providing Personal Health Record Information (PHR) in a terminal which stores and manages Virtual Personal Healthcare Record Information (VHR), by receiving a request for a PHR list from a healthcare terminal of a manager, managing a user's health, providing the PHR list to the healthcare terminal, receiving a request for at least one PHR included in the PHR list from the healthcare terminal and performing authentication such that the healthcare terminal is provided with the at least one PHR.

According to another aspect of the present invention, there is provided a method for a healthcare terminal of a manager, managing user's health to be provided with Personal Health Record Information (PHR), by transmitting a request for a PHR list to a terminal which stores and manages Virtual Personal Healthcare Record Information (VHR), receiving the PHR list from the terminal, transmitting a request for at least one PHR included in the PHR list to the terminal, performing authentication with the terminal such that the healthcare terminal is provided with the at least one PHR; and obtaining the at least one PHR from a device which stores and manages PHR.

According to another aspect of the present invention, there is provided an apparatus for providing Personal Health Record Information (PHR), the apparatus comprising a Virtual Personal Healthcare Record Information (VHR) management unit for storing and managing VHR, a PHR providing management unit for providing a PHR list to a healthcare terminal of a manager, managing a user's health; and an authentication management unit for performing authentication such that the healthcare terminal is provided with the at least one PHR stored inside or outside the healthcare terminal.

According to another aspect of the present invention, there is provided a healthcare terminal of a manager, managing a user's health, the healthcare terminal comprising a Personal Healthcare Record Information (PHR) selector for selecting at least one PHR to be read by the manager from a PHR list provided from a terminal which stores and manages Virtual Personal Healthcare Record Information (VHR), and a PHR reading processor for checking the at least one PHR by using information received through authentication with the terminal.

### BRIEF DESCRIPTION OF THE DRAWINGS

The above and other aspects, features and advantages of various embodiments of the present invention will be more apparent from the following detailed description taken in conjunction with the accompanying drawings, in which:

FIG. 1 is a block diagram illustrating a system for providing Personal Health Record information (PHR), according to an embodiment of the present invention;

FIG. 2 is a block diagram illustrating a patient terminal, according to an embodiment of the present invention;

FIG. 3 is a block diagram illustrating a healthcare terminal, according to an embodiment of the present invention;

FIG. 4 is a signal flow diagram illustrating a method for providing PHR, according to an embodiment of the present invention;

FIG. 5 is a diagram illustrating a PHR list request message used in a method for providing PHR, according to an embodiment of the present invention;

FIG. 6 is a diagram illustrating a message for sending an authentication certificate, used in a method for providing PHR, according to an embodiment of the present invention;

FIG. 7 is a diagram illustrating step 402 for checking PHR in FIG. 4, according to an embodiment of the present invention;

FIG. 8 is a flowchart illustrating a process of controlling generation of PHR in a method for providing PHR, according to an embodiment of the present invention; and

FIG. 9 is a diagram illustrating a message for requesting generation of a PHR used in a method for providing PHR, according to an embodiment of the present invention.

### DETAILED DESCRIPTION OF THE EMBODIMENTS OF THE PRESENT INVENTION

Hereinafter, various embodiments of the present invention will be described in detail with reference to the accompanying drawings. In the following description, specific details such as detailed configuration and components are merely provided to assist the overall understanding of the present invention. Further, detailed description of known functions and configurations are omitted to avoid obscuring the subject matter of the present invention.

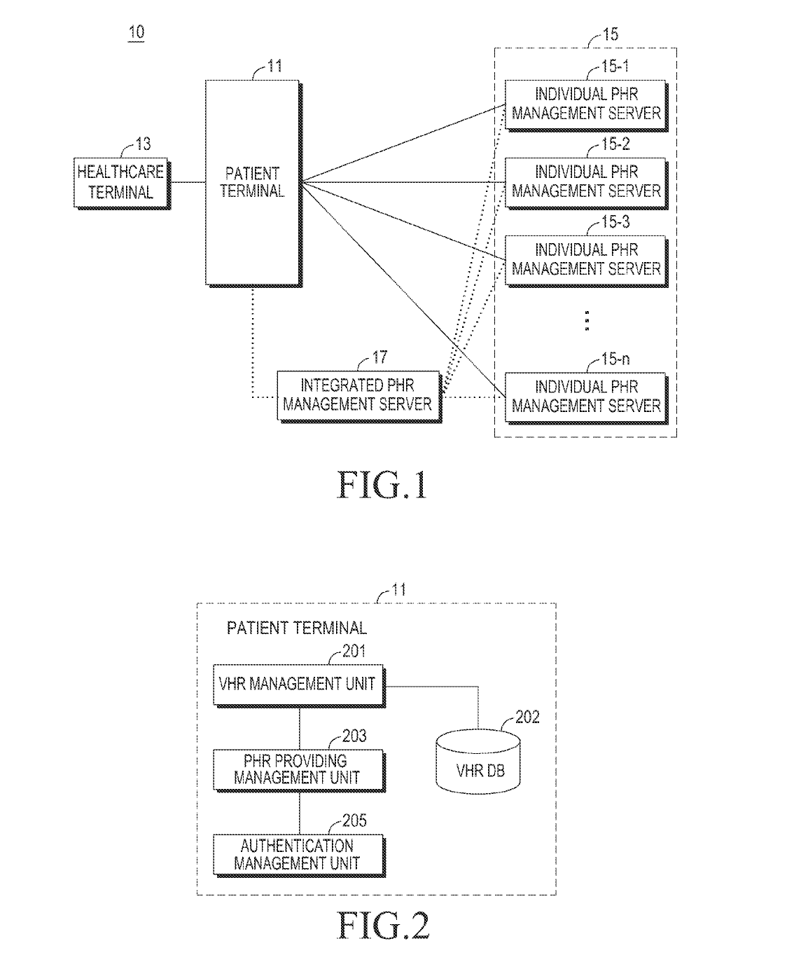

FIG. 1 is a block diagram illustrating a system 10, which is a system for providing Personal Health Record information (PHR) which performs a method for providing PHR, according to an embodiment of the present invention.

Referring to FIG. 1, the PHR providing system 10 includes a patient terminal 11, a healthcare terminal 13, and individual PHR management servers 15-1, 15-2, 15-3, . . . , 15-n (collectively referred to as an individual PHR management server 15).

The PHR providing system 10 provides PHR provided by the individual PHR management server 15 to the healthcare terminal 13 through the patient terminal 11. The patient terminal 11 is a terminal used by a user which PHR concerns, the healthcare terminal 13 is a terminal used by a manager (i.e., a doctor), managing health of the user (e.g., a patient) of the patient terminal 11, and the individual PHR management server 15 is a server for receiving overall health information of the user, such as a server used by a medical institution like a pharmacy or a hospital, a server used in a fitness center like a health club for managing exercise of the user (e.g., the patient) of the patient terminal 11, or a server used in an insurance company for managing insurance clauses or insurance application details of the user (e.g., the patient) of the patient terminal 11. Thus, the individual PHR management servers 15-1, 15-2, 15-3, . . . , 15-n are separately provided in a medical institution, a fitness center, an insurance company, and so forth, such that they receives and store PHR of the user (e.g., the patient).

The PHR stored in the individual PHR management servers 15-1, 15-2, 15-3, . . . , 15-n includes an identifier, owner information, generation/update time and date information, management agency information, an access authority class, detailed information of the PHR, and storage location information. More specifically, the identifier of the PHR may be a PHR ID, the owner information may be information such as a user name, a user ID, or the like, the generation/update time and date information may be information such as time and date on which the PHR is generated/updated, the number of times the PHR is updated, or the like, and the management agency information may be information such as name, contact number, location, information of a person in charge, a medical treatment purpose, or the like. The access authority class is a class of access to the individual PHR management server 15 and include information such as disclosure to an owner, disclosure to a healthcare manager (a doctor, etc.), disclosure to all, disclosure to a particular authorizer, etc. The storage location information may be information such as a Uniform Resource Locator (URL) of the individual PHR management server 15 in which the PHR is stored.

The PHR providing system 10 includes the individual PHR management server 15, and the PHR is provided through the individual PHR management server 15. However, the present invention is not limited thereto. Alternatively, for example, the PHR providing system 10 may further include an integrated PHR management server 17 for collecting PHR of the user (e.g., the patient) from the individual PHR management servers 15-1, 15-2, 15-3, . . . , 15-n separately provided in the medical institution, the fitness center, the insurance company, etc., and managing the PHR in an integrated manner. Thus, the integrated PHR management server 17 provides the PHR integrated for the user (e.g., the patient) to the patient terminal 11 or the healthcare terminal 13, and provides the PHR integrated for the user (e.g., the patient) through a web page or the like.

The patient terminal 11 manages authentication required to process management of Virtual Personal Healthcare Record information (VHR), management of a PHR list, and provisioning of PHR.

When the individual PHR management servers 15-1, 15-2, 15-3, . . . , 15-n store/update PHR, they provide index information of PHR to the patient terminal 11 through authentication of the patient terminal 11. Thus, the patient terminal 11 generates and manages the VHR including the index information of the respective PHR in a metadata format. Herein, the index information includes some information of the PHR, that is, the PHR identifier, the owner information, the generation/update time and date, the management agency information, the access authority class, the storage location information. The index information may further include authentication information which includes access authority class information and access authority authentication information. The authority authentication information includes information required for authentication used for the patient terminal 11 and the individual PHR management server 15 to provide PHR. The authority authentication information may be shared through prior authentication between the patient terminal 11 and the individual PHR management server 15, and may use, for example, an X.509 authentication certificate. The authentication certificate may be issued by the individual PHR management server 15 or issued from a separate authentication center which manages the authentication certificate and shared between the patient terminal 11 and the individual PHR management server 15. The authentication certificate includes authentication key owner information, an authentication certificate identification number, an authentication certificate version, a signature algorithm, an authentication authority, and so forth.

The VHR further includes attribute information of the PHR, and the attribute information includes PHR type information indicating a type of the PHR and data format information indicating a data format of the PHR. The type information indicates a type of the PHR and may be information for distinguishing a hospital, a drugstore, a fitness center, an insurance company, and so forth. Since even the same PHR may be in different data formats provided by management agencies, the data format information is information indicating the data format of PHR to identify the data format.

The patient terminal 11, upon receiving a request for PHR provisioning from the healthcare terminal 13, manages authentication corresponding to the healthcare terminal 13. More specifically, based on the access authority class information, the patient terminal 11 determines whether the healthcare terminal 13 is of a class which can be provided with PHR. If the healthcare terminal 13 is of a class which can be provided with PHR, then the healthcare terminal 13 temporarily issues an authentication certificate necessary for obtaining PHR, and provides the authentication certificate to the healthcare terminal 13.

The healthcare terminal 13 provides the PHR list to a manager (e.g., a doctor), managing patient's health, that is, a user who uses the healthcare terminal 13. The healthcare terminal 13 receives a selection of at least one PHR which may be helpful for making a diagnosis to the patient by referring to a name of PHR included in the PHR list and information about a PHR generation agency from the manager. The healthcare terminal 13 obtains the PHR from the individual PHR management servers 15-1, 15-2, 15-3, . . . , 15-n by using information necessary for obtaining PHR from the patient terminal 11 (e.g., a temporary authentication certificate, a Personal Identification Number (PIN) code, etc.).

FIG. 2 is a block diagram of the patient terminal 11 according to an embodiment of the present invention. Referring to FIG. 2, the patient terminal 11 includes a VHR management unit 201, a VHR database (DB) 202, a PHR providing management unit 203, and an authentication management unit 205.

The VHR management unit 201 performs a function of storing and managing VHR, such that the VHR management unit 201 generates VHR including index information of PHR received from the individual PHR management server 15, and stores and mages the VHR in the VHR DB 202.

The PHR providing management unit 203, upon receiving a request for a PHR list from the healthcare terminal 13, checks the VHR stored in the VHR DB 202, generates a PHR list included in the VHR, and provides the PHR list to the healthcare terminal 13. The PHR list includes a name of PHR and information about a PHR generation agency.

The authentication management unit 205 performs authentication used in the PHR providing system 10, and processes authentication required to transmit a request for generation of PHR to the individual PHR management server 15 and authentication required for the healthcare terminal 13 to be provided with PHR. More specifically, the authentication management unit 205, when transmitting a request for generation of PHR to the individual PHR management server 15, transmits user information (patient's ID, etc.) and authentication information (PIN code, etc.) to the individual PHR management server 15 to process authentication corresponding to the request. In order for the healthcare terminal 13 to provide PHR, authentication of whether the healthcare terminal 13 requesting PHR provisioning has access authority is performed based on an access authority class included in the VHR, and the healthcare terminal 13 temporarily issues and provides an authentication certificate required for the healthcare terminal 13 to be provided with the PHR.

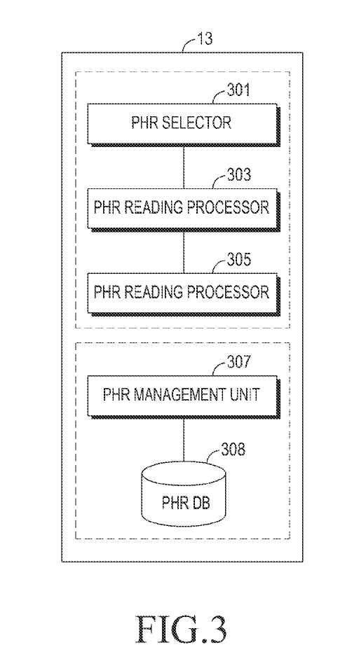

FIG. 3 is a block diagram illustrating the healthcare terminal 13 according to an embodiment of the present invention. Referring to FIG. 3, the healthcare terminal 13 includes a PHR selector 301, a PHR reading processor 303, and a PHR updater 305.

In order to be provided with PHR, the PHR selector 301 transmits a request for a PHR list owned by the patient terminal 11 to the patient terminal 11 and receives the PHR list from the patient terminal 11, and provides the received PHR list to a manager (doctor, etc.) of the healthcare terminal 13, such that the PHR selector 301 receives a selection of PHR required for medical treatment of the patient from the manager (doctor, etc.).

The PHR reading processor 303 transmits a request for an identifier of the selected PHR, information about a location in which the selected PHR is stored, and authentication information required for providing the selected PHR to the patient terminal 11 and receives them from the patient terminal 11. Thus, the PHR reading processor 303 transmits the authentication information together with the identifier of the selected PHR to the individual PHR management server 15 based on the information about the location in which the selected PHR is stored, and obtains the selected PHR. The PHR reading processor 303 provides the provided selected PHR to the manager.

The PHR updater 305, upon receiving new PHR detailed information from the manager, transmits the received PHR detailed information to the individual PHR management server 15 to update corresponding PHR. The PHR updater 305 may newly generate and store PHR including the received PHR detailed information. To this end, the healthcare terminal 13 may further include a PHR management unit 307 and a PHR DB 308. When PHR is newly generated, the PHR updater 305 may transmit a request for generation of PHR to the PHR management unit 307. In response to the request, the PHR management unit 307 generates PHR including the received PHR detailed information, stores the generated PHR in the PHR DB 308, and provides index information about the generated PHR to the patient terminal 11.

According to an embodiment of the present invention, the PHR updater 305 of the healthcare terminal 13 receives input of updated PHR for the user who uses the healthcare terminal 13 from the manager (e.g., a doctor), managing health of the patient terminal 11. The PHR updater 305 updates PHR according to the input of the manager. The healthcare terminal 13 transmits a request for update of PHR in the patient terminal 11 or the individual PHR management server 15 which stores the PHR.

The PHR management unit 307 and the PHR DB 308 may be provided inside the healthcare terminal 13 or may be included in the individual PHR management server 15 to be provided in a remote place and may be connected with the healthcare terminal 13 over a communication network.

Moreover, the PHR providing system 10 may be applied to a Universal Plug and Play (UPnP) device architecture.

More specifically, the VHR management unit 201 included in the patient terminal 11 may function as a UPnP Control Point (CP) for receiving index information of PHR from the individual PHR management server 15, and the VHR DB 202, the PHR providing management unit 203, and the authentication management unit 205 may function as UPnP servers for providing the PHR list, the identifier of the selected PHR, the information about the location in which the selected PHR is stored, and the authentication information required for providing the selected PHR to the healthcare terminal 13.

The PHR selector 301, the PHR reading processor 303, and the PHR updater 305 included in the healthcare terminal 13 may function as UPnP CPs for transmitting a request for the PHR list, the identifier of the selected PHR, the information about the location in which the selected PHR is stored, and the authentication information required for providing the selected PHR to the patient terminal 11 and receiving them from the patient terminal 11. The PHR selector 301, the PHR reading processor 303, and the PHR updater 305 may function as UPnP CPs for transmitting a request for PHR to the individual PHR management server 15 and receiving them from the individual PHR management server 15. The PHR management unit 307 and the PHR DB 308 may function as UPnP servers for storing and managing PHR.

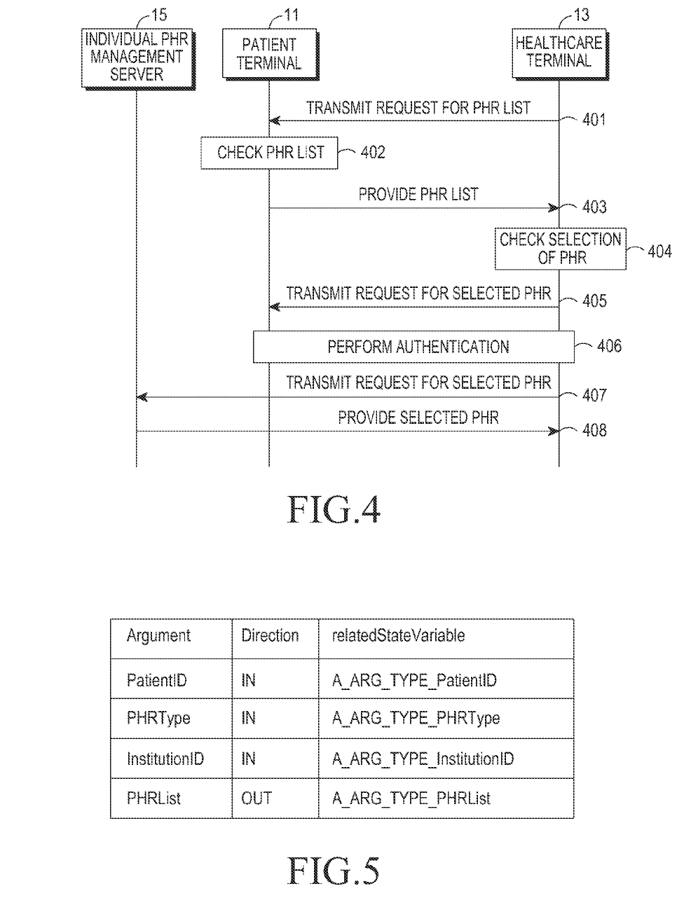

FIG. 4 is a signal flow diagram illustrating a method for providing PHR according to an embodiment of the present invention.

First, the method provides PHR to the healthcare terminal 13 from the patient terminal 11. The healthcare terminal 13 transmits a request for providing a PHR list to the patient terminal 11 in step 401. In step 401, a PHR list request message transmitted from the healthcare terminal 13 to the patient terminal 11 may be as shown in FIG. 5. For example, the PHR list request message may carry a patient ID, PHR type information, and a manager ID to request provisioning of a PHR list corresponding to the PHR type information of a patient.

In step 402, the patient terminal 11 checks VHR stored therein to find a PHR list which is stored in the VHR and corresponds to the PHR type information. The patient terminal 11 transmits the PHR list to the healthcare terminal 13 in step 403. The PHR list contains an identifier of at least one PHR included in the VHR, a name of the PHR, and information about a PHR generation agency.

In step 402, the patient terminal 11 may filter the PHR list of the at least one PHR included in the VHR to provide the PHR list. For example, the patient terminal 11 provides the PHR list of the at least one PHR included in the VHR to the user, receive a selection of PHR to be included in the PHR list from the user, generate the PHR list of the selected PHR, and transmit the PHR list to the healthcare terminal 13.

In step 404, the healthcare terminal 13 receives and checks a manager's selection of the PHR included in the PHR list received from the patient terminal. To check if the PHR is helpful to the manager to make an accurate diagnosis on the patient by using reliable and various information, the healthcare terminal 13 provides the PHR list to the manager (e.g., the doctor) and receives a selection of PHR. Thus, the manager (e.g., the doctor) selects and inputs at least one PHR which is helpful to make a diagnosis on the patient by using the name of the PHR included in the PHR list and the information about the PHR generation agency. In step 405, the healthcare terminal 13 requests provisioning of the selected PHR by using the identifier of the selected PHR.

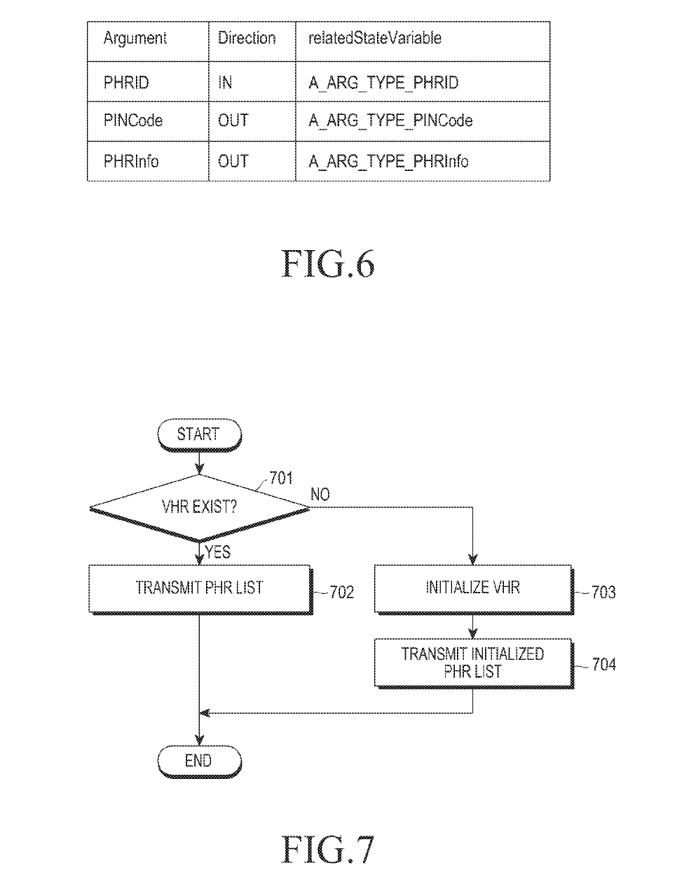

In step 406, the patient terminal 11 checks authentication information of the selected PHR, especially, access authority class information including a class of access to the PHR included in the authentication information, to determine whether the healthcare terminal 13 satisfies the access authority class. If the healthcare terminal 13 satisfies the access authority class, the patient terminal 11 issues an authentication certificate required for the healthcare terminal 13 to be provided with the selected PHR and provides the issued authentication certificate to the healthcare terminal 13. The issued authentication certificate required to be provided with the selected PHR is a temporary authentication certificate, and includes an authentication certificate which is set for the healthcare terminal 13 to be provided with the selected PHR once. For example, a message for transmitting the authentication certificate may be as shown in FIG. 6.

Although in an embodiment of the present invention, authentication is performed corresponding to the healthcare terminal 13 by using the access authority class and the temporary authentication certificate in step 406, the present invention is not limited thereto. For example, the patient terminal 11 may perform authentication based on a user's input. More specifically, upon receiving the request for providing the selected PHR, the patient terminal 11 determines whether provisioning of the selected PHR is approved. Approval of provisioning of the selected PHR may be determined automatically according to preset information which is preset in the patient terminal 11 by the user in response to the request for providing the selected PHR. Alternatively, approval of provisioning of the selected PHR may be determined according to user's direct input. That is, by using an identifier of the healthcare terminal 13 and an identifier of the selected PHR, the healthcare terminal 13 notifies the patient terminal 11 that the healthcare terminal 13 requests the selected PHR, and requests input of whether provisioning of the selected PHR is approved. The patient terminal 11 provides the selected PHR according to a result which is inputted from the user. That is, if the input of the selected PHR is approved from the user, then the patient terminal 11 provides information required to be provided with the selected PHR, e.g., a PIN code corresponding to the selected PHR to the healthcare terminal 13.

Next, in step 407, the healthcare terminal 13 transmits a request for providing the PHR to the individual PHR management server 15 in which the selected PHR is stored, by using the temporary authentication certificate (or PIN code) provided form the patient terminal 11.

Thus, the individual PHR management server 15 checks an identification number of the selected PHR, and first checks if the temporary authentication certificate (or PIN code) corresponding to the selected PHR is effective for the user (patient). If the temporary authentication certificate (or PIN code) is effective for the user (patient), the individual PHR management server 15 provides the selected PHR to the healthcare terminal 13 in step 408.

FIG. 7 is a detailed diagram illustrating step 402 in FIG. 4, in which the PHR is checked. Referring to FIG. 7, the PHR list is checked as follows. First, the patient terminal 11 checks if the VHR exists in the patient terminal 11 in step 701. If the VHR exists (YES in step 701), the patient terminal 11 checks a PHR list included in the VHR and provides the PHR list in step 702. On the other hand, if the VHR does not exist (NO in step 701), the patient terminal 11 initializes the VHR in step 703. That is, the patient terminal 11 sets a field for the PHR included in the VHR to a null state.

Next, the patient terminal 11 generates an initial PHR list, that is, the initialized PHR list from the VHR set to the null state, and transmits the generated initial PHR list to the healthcare terminal 13 in step 704.

The patient terminal 11 may control generation of the PHR stored and managed in the individual PHR management server 15.

FIG. 8 is a flowchart illustrating a process of controlling generation of PHR in a method for providing PHR according to an embodiment of the present invention.

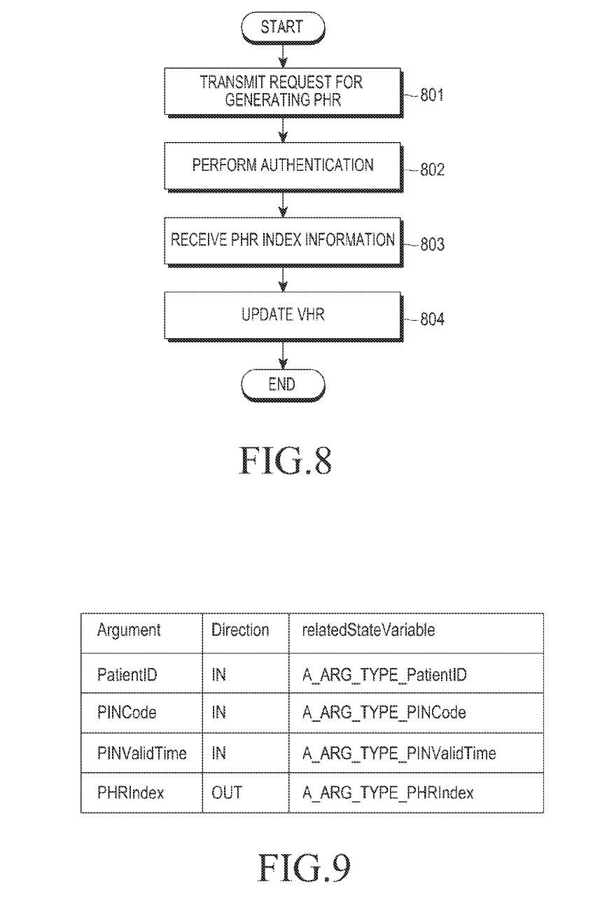

In step 801, the patient terminal 11 transmits a request for generating PHR to the individual PHR management server 15. The request for generating the PHR may be generated by user's input or automatically generated according to a predefined rule. For example, the patient terminal 11 receives an identifier indicating a management agency which manages the individual PHR management server 15 from the individual PHR management server 15, and if the management agency is a predetermined institution, e.g., a hospital, a drugstore, or the like, the patient terminal 11 may automatically request generation of PHR without a separate input from the user. A message for requesting generation of PHR may be as shown in FIG. 9.

In step 802, the patient terminal 11 performs authentication with the individual PHR management server 15 in response to generation of the PHR. More specifically, the patient terminal 11 transmits user information (for example, an ID of the patient or the like) and authentication certificate information (for example, a PIN code or the like) to the individual PHR management server 15.

Thus, the individual PHR management server 15 compares the previously stored user information (the ID of the patient or the like) and the authentication certificate information (the PIN code or the like) with the received information to determine whether the received information is effective information. If the received information is effective information, the individual PHR management server 15 receives detailed information of the PHR from outside, generates index information of the PHR, and provides the generated index information to the patient terminal 11. Hence, the patient terminal 11 receives the index information of the PHR in step 803. In step 804, the patient terminal 11 reflects the received index information to update the VHR.

Step 801 may be electively performed. For example, the individual PHR management server 15 may generate the PHR to transmit a request for authentication to the patient terminal 11, without separately receiving the request for generating the PHR from the patient terminal 11. In this case, the patient terminal 11 may be notified from the individual PHR management server 15 that the PHR is generated and perform authentication for generation of the PHR, without performing step 801.

According to the present invention, various personal health records distributed over multiple management agencies are integrated and managed in a patient-oriented manner, thus being helpful for tracking a patient's personal clinical history.

Moreover, as personal health records are managed in a patient-oriented manner, inadvertent release of personal health records such as medical records may be prevented.

Furthermore, by easily providing various personal health records managed in a patient-oriented manner to a manager such as a doctor, effective treatment and diagnosis are possible based on the personal health records and an accurate diagnosis and an effective treatment can be made.

While the present invention has been shown and described with reference to various embodiments thereof, it will be understood by those of ordinary skill in the art that various changes in form and detail may be made without departing from the spirit and scope of the present invention as defined by the appended claims.

What is claimed is:

1. A method for providing Personal Health Record Information (PHR) in a terminal which stores and manages Virtual Personal Healthcare Record Information (VHR), the method comprising:
receiving a request for a PHR list from a healthcare terminal of a manager, managing a user's health;
providing the PHR list to the healthcare terminal;
receiving a request for at least one PHR included in the PHR list from the healthcare terminal; and
performing authentication such that the healthcare terminal is provided with the at least one PHR.

2. The method of claim 1, wherein the VHR includes index information including information about the at least one PHR and authentication information about access to the PHR.

3. The method of claim 2, wherein the index information includes attribute information of the PHR and a storage location of the PHR, and
wherein the attribute information of the PHR includes type information indicating a type of the PHR and data format information indicating a data format of the PHR.

4. The method of claim 2, wherein the authentication information includes at least one of access authority class information including a class of access to the PHR, an authentication key, owner information of the authentication key, an identification number of an authentication certificate, and access authority authentication information including an authentication authority.

5. The method of claim 1, wherein performing authentication comprises:
generating a temporary authentication certificate, which is used by the healthcare terminal to read the at least one PHR; and
transmitting the temporary authentication certificate to the healthcare terminal to allow the healthcare terminal to read the at least one PHR by using the temporary authentication certificate.

6. The method of claim 1, wherein performing authentication comprises:
receiving a request for reading of the at least one of PHR from the healthcare terminal;
receiving user input regarding whether to read the at least one PHR by the healthcare terminal; and
providing information required for reading the at least one PHR to the healthcare terminal according to the user input result.

7. The method of claim 2, further comprising:
receiving a request for updating the PHR from the healthcare terminal which reads the at least one PHR; and
updating the PHR.

8. The method of claim 7, wherein updating the PHR comprises:
reflecting and storing update information in the PHR; and
updating index information corresponding to the PHR.

9. The method of claim 1, after receiving the request for the at least one PHR included in the PHR list from the healthcare terminal, further comprising:
checking if the VHR exists; and
if the VHR doesn't exit, initializing and storing the VHR.

10. The method of claim 1, further comprising:
transmitting a request for generating the PHR, to a device, which stores and manages the user's PHR;
performing authentication corresponding to the request for generating the PHR;
receiving index information regarding the generated PHR from the device; and
updating the index information regarding to the generated PHR in the VHR.

11. A method for a healthcare terminal of a manager, managing a user's health to be provided with Personal Health Record Information (PHR), the method comprising:
transmitting a request for a PHR list to a terminal which stores and manages Virtual Personal Healthcare Record Information (VHR);
receiving the PHR list from the terminal;
transmitting a request for at least one PHR included in the PHR list to the terminal;
performing authentication with the terminal such that the healthcare terminal is provided with the at least one PHR; and
obtaining the at least one PHR from a device which stores and manages PHR.

12. The method of claim 11, wherein the VHR includes index information which includes information about the at least one PHR and authentication information about access to the PHR.

13. The method of claim 11, wherein performing authentication comprises:
receiving a temporary authentication certificate, which is used by the healthcare terminal to read the at least one PHR, from the terminal;
transmitting a request for reading the at least one PHR to the device by using the temporary authentication certificate; and
obtaining the at least one PHR from the device.

14. The method of claim 11, wherein performing authentication comprises:
if the terminal receives user input regarding whether to read the at least one PHR and provides information required for reading the at least one PHR,
transmitting a request for providing the at least one PHR to the device by using the information required for reading the at least one PHR; and
obtaining the at least one PHR from the device.

15. The method of claim 11, further comprising:
receiving input for updating the PHR from a manager, managing health of the user; and
transmitting a request for updating the PHR by using the input, to the terminal or the device which stores and manages the PHR of the user.

16. An apparatus for providing Personal Health Record Information (PHR), the apparatus comprising:
a Virtual Personal Healthcare Record Information (VHR) management unit for storing and managing VHR;
a PHR providing management unit for providing a PHR list to a healthcare terminal of a manager, managing a user's health; and
an authentication management unit for performing authentication such that the healthcare terminal is provided with the at least one PHR stored inside or outside the healthcare terminal.

17. The apparatus of claim 16, wherein the authentication management unit stores and manages an authentication certificate required for managing the at least one PHR, and issues and provides a temporary authentication certificate for obtaining the at least one PHR to the healthcare terminal.

18. A healthcare terminal of a manager, managing a user's health, the healthcare terminal comprising:
a Personal Healthcare Record Information (PHR) selector for selecting at least one PHR to be read by the manager from a PHR list provided from a terminal which stores and manages Virtual Personal Healthcare Record Information (VHR); and
a PHR reading processor for checking the at least one PHR by using information received through authentication with the terminal.

19. The healthcare terminal of claim 18, wherein the PHR reading processor checks the at least one PHR by using a temporary authentication certificate received from the terminal.

20. The healthcare terminal of claim 19, wherein the PHR reading processor receives a security code for at least one PHR to be read by the manager from the terminal and obtains the at least one PHR to be read by the manager by using the security code.
